(19) United States
(12) Patent Application Publication
(10) Pub. No.: US 2023/0090270 A1
(43) Pub. Date: Mar. 23, 2023

(54) APPARATUS AND METHOD FOR ACQUIRING DATA FOR CONFIGURING A PNEUMATIC AIR GUN

(71) Applicant: DAYSTATE LIMITED, Stafford, Staffordshire (GB)

(72) Inventor: David SNOOK, (US)

(21) Appl. No.: 17/904,072

(22) PCT Filed: Mar. 3, 2021
(86) PCT No.: PCT/GB2021/050533

§ 371 Date: Aug. 11, 2022

(30) Foreign Application Priority Data
Mar. 3, 2020 (GB) 2003075.5

(51) Int. Cl. F41B 11/71; F41B 11/723; F41B 11/62; G05B 19/416

(52) U.S. Cl. CPC F41B 11/71; F41B 11/723; F41B 11/62; G05B 19/416; G05B 2219/37399

(57) ABSTRACT

Apparatus for acquiring data for configuring a pneumatic air gun comprises a data storage device and a controller. The controller is configured to determine a required velocity for a firing and determine a pressure of an air reservoir, or a pressure in an air flow path at a position downstream of the air reservoir of the gun. The controller is configured to determine a value of a valve activating parameter for the firing and determine a measured velocity of a projectile fired from the gun using the determined value of the valve activating parameter. The controller is configured to determine whether a difference between the measured velocity and the required velocity is within a required limit. The controller is configured to store the determined pressure and the determined value of the valve activating parameter in the data storage device as mapping data for configuring a future firing of the gun when the difference between the measured velocity and the required velocity is within the required limit.

### BACKGROUND

Pneumatic air guns, such as air rifles, use high pressure air which is stored in a pressurised air reservoir. Pulling a trigger of the gun releases a quantity of the stored high pressure air from the reservoir, via a release valve, to a breech of the gun and drives a pellet from the gun. Another term for this type of gun is precharged pneumatic (PCP).

With this type of gun, the pressure in the reservoir varies over a period of use. Initially the reservoir is fully charged to a high pressure. Over a period of use the pressure reduces until a point at which the reservoir will need recharging. Each time the release valve is opened the muzzle energy, and therefore the velocity of a pellet from the muzzle, is dependent on the air pressure in the reservoir at that particular point in time.

It is known to provide a pneumatic air gun with a solenoid controlled release valve. When a user pulls the trigger, a controller of the gun controls the solenoid to open the release valve. GB 2,417,312 A describes a pneumatic air gun which can maintain a more consistent muzzle velocity over a range of reservoir pressures. The gun described in this document monitors pressure in the reservoir via a sensor and uses a microprocessor to vary a length of a pulse applied to the solenoid release valve according to the pressure.

Typically, a gun of the type described in GB 2,417,312 A requires a stored set of data which maps a small number of pairs of data values of (i) pressure and (ii) pulse length. Typically, three pairs of data values are stored. The stored data is used to determine a pulse length for the current reservoir pressure. Each manufactured gun has different characteristics, due to small differences in components. Therefore, the stored set of data is specific to a particular gun. The set of data is obtained during a set up procedure in a factory. The set up procedure is a time-consuming process.

Pneumatic air guns can use a mechanical pressure regulator to provide a more consistent pressure over a period of use. However, pressure regulators can also suffer from a variation in pressure over a period of use. There is also an issue that when a pressure regulator is changed, a new pressure regulator can have a different response to the previous one. This can require factory recalibration of the gun.

It is an aim of the present invention to address at least one disadvantage associated with the prior art.

### SUMMARY OF THE INVENTION

A first aspect provides an apparatus for acquiring data for configuring a pneumatic air gun, the apparatus comprising:
a data storage device;
a controller configured to:
   determine a required velocity for a firing;
   determine a pressure of an air reservoir, or a pressure in an air flow path at a position downstream of the air reservoir of the gun;
   determine a value of a valve activating parameter for the firing, wherein the valve activating parameter is for an electrically operated valve to release a quantity of air from an air reservoir of the gun to fire a projectile;
   determine a measured velocity of a projectile fired from the gun using the determined value of the valve activating parameter;
   determine whether a difference between the measured velocity and the required velocity is within a required limit; and
   store the determined pressure and the determined value of the valve activating parameter in the data storage device as mapping data for configuring a future firing of the gun when the difference between the measured velocity and the required velocity is within the required limit.

Optionally, the controller is configured to acquire a set of mapping data for a plurality of different determined pressures at the required velocity.

Optionally, the controller is configured to:
adjust a value of the valve activating parameter when a difference between the measured velocity and the required velocity is outside the required limit; and
use the adjusted value of the valve activating parameter for a subsequent firing.

Optionally, the controller is configured to adjust the value of the valve activating parameter to increase quantity of air released from the reservoir if the measured velocity is less than the required velocity.

Optionally, the controller is configured to adjust the value of the valve activating parameter to reduce a quantity of air released from the reservoir if the measured velocity is higher than the required velocity.

Optionally, the controller is configured to retrieve, from the data storage device, an initial value of the valve activating parameter and use the starting value.

Optionally, the required velocity is a user-selectable velocity value.

Optionally, the controller is coupled to a user interface, and the user interface is configured to allow a user to select the required velocity.

Optionally, the valve activating parameter is a pulse length or a pulse voltage. There can be more than one valve activating parameter. For example, a first valve activating parameter can be pulse length and a second valve activating parameter can be pulse voltage.

Optionally, the electrically-operated actuator is a solenoid.

A second aspect provides a pneumatic air gun comprising:
a barrel;
a pressure sensor configured to determine a pressure of an air reservoir, or a pressure in an air flow path at a position downstream of the air reservoir of the gun;
a velocity measuring device configured to measure measured velocity of a projectile fired along the barrel of the gun; and
the apparatus according to the first aspect, wherein the data storage device and the controller form part of the pneumatic air gun.

A third aspect provides a system for configuring a pneumatic air gun comprising the apparatus according to the first aspect; wherein the controller is separate to the pneumatic air gun, and the controller is configured to:
determine the pressure of an air reservoir, or a pressure in an air flow path at a position downstream of the air reservoir of the gun using a pressure sensor of the pneumatic air gun;
determine the measured velocity of a projectile fired from the gun using a velocity measuring device which is separate to the pneumatic air gun.

Optionally, the controller is configured to transfer the mapping data to an on-gun controller of the pneumatic air gun under test to configure operation of the gun.

Another aspect provides a method of acquiring data for controlling operation of a pneumatic air gun, the pneumatic air gun comprising an air reservoir, an electrically operated valve operable to release a quantity of air from the air reservoir to fire a projectile and a velocity-measuring device configured to measure a velocity of a fired projectile, the method comprising:
determining a required velocity for a firing;
determining a pressure of the air reservoir;
determining a value of a valve activating parameter for the firing;
determining a measured velocity of a projectile fired using the determined value of the valve activating parameter;
determining whether a difference between the measured velocity and the required velocity is within a required limit; and
storing the determined pressure and the determined value of the valve activating parameter in a data storage device as mapping data for a future firing of the gun when the difference between the measured velocity and the required velocity is within the required limit.

Optionally, the method is performed by a controller on the pneumatic air gun, wherein:
the step of determining a pressure of an air reservoir, or a pressure in an air flow path at a position downstream of the air reservoir of the gun uses a pressure sensor of the pneumatic air gun;
the step of determining a measured velocity of a projectile uses a velocity measuring device on the barrel of the pneumatic air gun.

Optionally, the method is performed by a controller separate to the pneumatic air gun, wherein:
the step of determining a pressure of an air reservoir, or a pressure in an air flow path at a position downstream of the air reservoir of the gun uses a pressure sensor of the pneumatic air gun;
the step of determining a measured velocity of a projectile uses a velocity measuring device which is separate to the pneumatic air gun; and

the method comprises transferring the mapping data to an on-gun controller of the pneumatic air gun under test to configure operation of the gun.

Another aspect provides a computer program product comprising a machine-readable medium carrying instructions which, when executed by a processor, cause the processor to perform the disclosed method.

An advantage of at least one example or embodiment is a more efficient and accurate, self-compensating velocity regulation. This is particularly advantageous at extremes of low and high pressures. This can provide a more consistent velocity across a larger number of shots between recharging the air reservoir.

This technology can eliminate, or augment, mechanical regulators which introduce inefficiency and cannot easily compensate for temperature and gun wear.

An advantage of at least one example or embodiment is that it allows the gun to acquire values of a valve activating parameter for specific velocities that a user requires. The velocity may be determined by the type of ammunition. A set of data may be acquired by the gun and stored for later recall. In this way the user can easily select the required muzzle velocity for a specific application.

An advantage of at least one example or embodiment is a user programmable gun that has more efficiency, consistency and user information than its mechanical counterparts. Different calibrated velocities can be set up by a user without any extra equipment.

The controller described here can be implemented in hardware, software executed by a processing apparatus, or by a combination of hardware and software. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to perform the required functions. Another aspect of the invention provides machine-readable instructions (software) which, when executed by a processor, perform any of the described methods. The machine-readable instructions may be stored on an electronic memory device, hard disk, optical disk or other machine-readable storage medium. The machine-readable medium can be a non-transitory machine-readable medium. The term “non-transitory machine-readable medium” comprises all machine-readable media except for a transitory, propagating signal. The machine-readable instructions can be downloaded to the storage medium via a network connection.

Within the scope of this application it is envisaged that the various aspects, embodiments, examples and alternatives, and in particular the individual features thereof, set out in the preceding paragraphs, in the claims and/or in the following description and drawings, may be taken independently or in any combination. For example features described in connection with one embodiment are applicable to all embodiments, unless such features are incompatible.

For the avoidance of doubt, it is to be understood that features described with respect to one aspect of the invention may be included within any other aspect of the invention, alone or in appropriate combination with one or more other features.

### BRIEF DESCRIPTION OF THE DRAWINGS

One or more embodiments of the invention will now be described, by way of example only, with reference to the accompanying figures in which:

FIG. 1 shows an example pneumatic air gun;

FIG. 2 schematically shows a pneumatic air gun and a control system for the gun;

FIG. 3 shows an example method performed by the control system of FIG. 2;

FIG. 4 shows a graph of mapping data obtained using the method of FIG. 3;

FIG. 5 shows a graph of mapping data obtained using a prior art method;

FIG. 6 shows an example of a controller for the pneumatic air gun of FIG. 2;

FIG. 7 shows a system for configuring mapping data for a pneumatic air gun;

FIG. 8 shows an example method performed by the control system of FIG. 7.

### DETAILED DESCRIPTION

Two systems for acquiring data for configuring a pneumatic air gun data will now be described: an on-gun calibration system, and an off-gun calibration system. In the on-gun calibration system, the gun comprises a chronoscope and a controller in the gun can acquire mapping data for itself. In effect, the gun is self-learning. In the off-gun calibration system, an off-gun chronoscope in a test facility is used to measure velocity of fired shots. A controller acquires mapping data. The on-gun controller is configured with this mapping data. This system is also self-learning during the calibration process. The gun can only use the configured data when it is removed from the test facility. Once the gun is removed from the test facility, it does not acquire updated mapping data for itself.

On-Gun Calibration System (AVT)

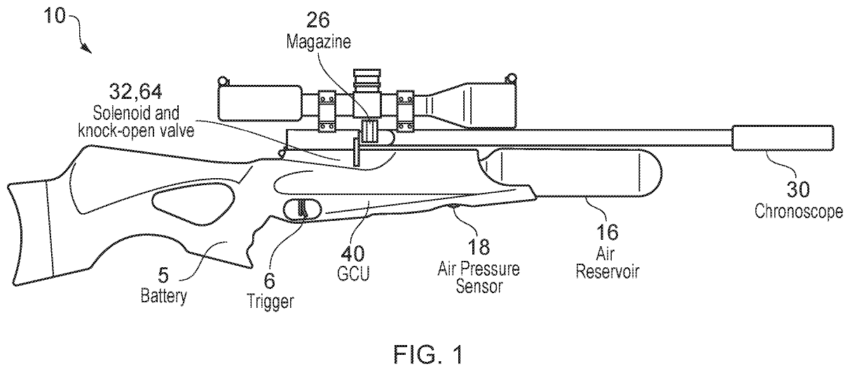

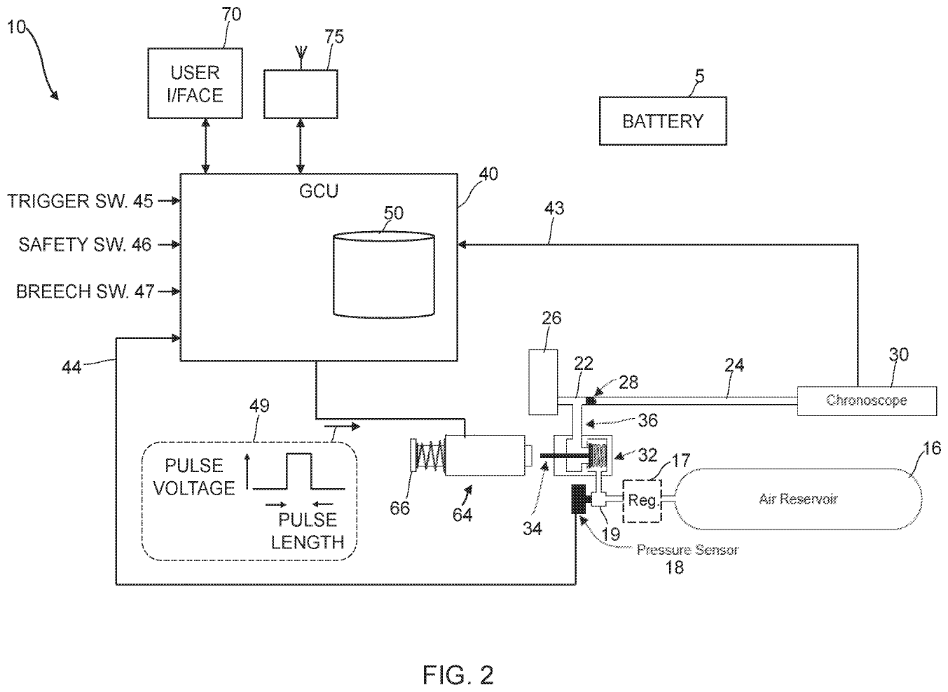

FIG. 1 shows an example of a pneumatic air gun. FIG. 2 schematically shows elements of the pneumatic air gun 10 and of a control system for the gun.

The gun 10 has a breech 22 and a barrel 24. The gun fires ammunition in the form of projectiles, such as pellets. A quantity of ammunition may be provided in a magazine 26. A mechanism (not shown) may automatically load a projectile from the magazine 26 into the breech 22 in preparation for firing. Alternatively, a pellet (or other form of projectile) may be loaded individually into the breech 22 by hand.

An air reservoir 16 stores a quantity of compressed air. The compressed air provides the propellant for the projectile. Over a period of use the pressure in the air reservoir 16 will vary. The air reservoir 16 may be recharged.

An air flow path is provided between an outlet of the air reservoir 16 and the breech 22. A valve 32 is located in the air flow path from the air reservoir 16. A transfer port 36 connects a downstream side of the valve 32 to the breech 22. The valve 32 is movable between a closed (sealed) position and an open position. The valve 32 acts upon an outlet port in the air flow path. The valve 32 is biased by a valve return spring to the closed position. In the closed position the valve 32 seals against the outlet port and prevents air from reaching the transfer port 36. In the open position the valve 32 allows air to flow from the air reservoir 16 to the transfer port 36, via the outlet port, and into the breech 22. The valve 32 has a stem 34 which extends from the valve. In this example the valve 32 is a knock-open valve. The valve 32 has a seal which lies on an upstream side of the outlet port. In the closed position the high pressure air within reservoir 16 presses against the valve 32, causing the valve 32 to seal against the outlet port. The valve 32 can be knocked open by applying a force to stem 34. When the force applied to the stem 34 is higher than the force provided by the air on the opposing side of the valve 32 and the valve return spring, the valve 32 will open. A pulse (or packet) of air is released through the transfer port 36. This pulse of air drives the projectile 28 along the barrel. The valve 32 will return to the closed position under the influence of the high pressure air within the reservoir 16 and the valve return spring.

Optionally, the air flow path may include a mechanical pressure regulator 17 and a plenum chamber 19, or an electronic pressure regulator 17 and a plenum chamber 19. The mechanical pressure regulator (or electronic pressure regulator) 17 is configured to regulate air pressure of air in the plenum chamber 19. Ideally, the mechanical pressure regulator (or electronic pressure regulator) 17 will attempt to maintain a substantially constant pressure in the plenum chamber 19 over a range of pressures within the reservoir 16. When the pressure in the reservoir 16 falls below the operating point of the mechanical pressure regulator (or electronic pressure regulator), the pressure in the plenum chamber 19 will fall. In practice, there will be some variation in regulated pressure over a range of pressures within the reservoir 16. The regulated pressure may also vary when the mechanical pressure regulator (or electronic pressure regulator) is changed.

A Gun Control Unit (GCU) 40 controls operation of the gun. The GCU 40 uses a memory 50, or other data storage device, to store data. The memory 50 may be provided as part of the GCU 40 (e.g. as a memory on a microcontroller board) or may be provided separately to the GCU 40.

The GCU 40 receives a set of input signals. One input signal 45 is indicative of when the trigger 6 of the gun is activated. Another input signal 46 is indicative of a state of a safety switch on the gun (safety switch 46). The safety switch is a safety interlock. The gun is disarmed when the safety switch is turned on. Another input signal 47 is indicative of whether the breech 22 is open or closed. Status of the breech is monitored by a breech switch. The breech open/closed switch is another safety interlock and prevents the gun from firing when the breech is open.

A pressure sensor 18 is configured to measure pressure of the air reservoir 16 or to measure pressure in an air flow path at a position downstream of the air reservoir 16, such as the plenum chamber 19. The GCU receives an input signal 44 from the pressure sensor 18. Signal 44 is indicative of the measured pressure.

The gun may have a user interface 70. The user interface may comprise a display. The user interface 70 may allow a user to select a value of an operating parameter of the gun, such as velocity. The user interface may comprise physical buttons, a touch screen or some other form of user input device. The GCU 40 communicates with the user interface 70.

The GCU 40 outputs control signals to control operation of the gun. The valve 32 is electrically operated by a solenoid 64. The solenoid 64 has a solenoid hammer 66 (i.e. the movable armature of the solenoid) and a return spring. The solenoid may be a high power, low duty solenoid. When the solenoid 64 is energised, the solenoid hammer hits the stem 34 of the valve 32 and moves the valve 32 to the open position. This controls an air-pulse packet applied to the breech 22 to fire a projectile.

The solenoid 64 is operated by an electrical pulse. The pulse has two parameters: pulse voltage and pulse length. The GCU may vary one, or both, of these parameters to control the pulse supplied to the solenoid 64. For example, the GCU may: (i) maintain a constant pulse voltage and vary pulse length; (ii) vary pulse voltage and vary pulse length. The term “pulse length” describes the length of a pulse in the control signal 49 which drives the solenoid 64 to activate the valve 32. The length of a pulse in the control signal 49 (also called a pulse width, or pulse width modulation) controls the length of a pulse of electrical energy supplied to the solenoid 64. A single high-power pulse of electrical energy drives the solenoid.

FIG. 2 shows the GCU directly outputting a pulse to the solenoid. It will be understood that there are other ways in which this could be implemented. For example, there can be an electrical circuit (not shown) connected to the solenoid for generating the electrical pulse, and the GCU may control the electrical circuit to generate a pulse with a particular pulse length, or a particular pulse length and voltage.

The GCU 40 receives an input signal 43 from a chronoscope 30 (also called a chronograph). As described below, this input signal 43 may either directly provide the GCU with velocity of a fired projectile, or may provide information which allows the GCU to calculate the velocity of a fired projectile.

The pulse length/width varies during operation. The pulse length/width selected by the GCU is determined by measured air pressure. An opening force for the valve 32 varies according to air pressure on the valve 32. At high pressures a high opening force is required. At lower pressures a lower opening force is required. The pulse length/width selected by the GCU is determined by a stored value if mapping data is available in memory 50. The pulse length/width selected by the GCU may be determined based on any error between the required velocity and the actual velocity of the shot. This error correction is then used with the next shot.

A chronoscope 30 is provided as part of the barrel 24. The chronoscope 30 may be located at, or near, the distal end of the barrel 24. This part of the barrel 24 is called the muzzle. The chronoscope 30 determines a velocity of a projectile passing along the barrel 24. The chronoscope 30 is used to measure the velocity of the projectile. This information is used by the GCU 40 to control the velocity of the fired projectile and record results.

The chronoscope 30 may operate in various ways. In one type of chronoscope, two light barriers are provided at spaced-apart positions along the barrel 24. Each light barrier is directed across the barrel 24. A light barrier comprises a light-emitting source and a light detector. The light-emitting source, such as a Light Emitting Diode (LED), emits a light beam across the barrel. The light detector is aligned with the light-emitting source and is configured to detect the presence of the light beam. When a projectile crosses the first light beam, a reduced amount of light reaches the light detector. Control circuitry detects the absence (or a reduced intensity of) the first light beam. When the projectile crosses the second light beam, the light detector detects the absence (or a reduced intensity of) the second light beam. The chronoscope determines a time difference between the times when the first light beam is crossed and the second light beam is crossed. The time difference and the known distance between the two light barriers gives the velocity of the projectile.

The GCU may determine velocity of a projectile using outputs of the chronoscope. For example, the chronoscope 30 may output a first signal from the first light detector and output a second signal from the second light detector and the GCU may determine a time difference between the first signal and the second signal. The GCU can determine velocity from the known distance between the light barriers (a fixed value) and the time difference between the first signal and the second signal. Alternatively, a processor at the chronoscope may determine velocity of a projectile and output the determined velocity to the GCU.

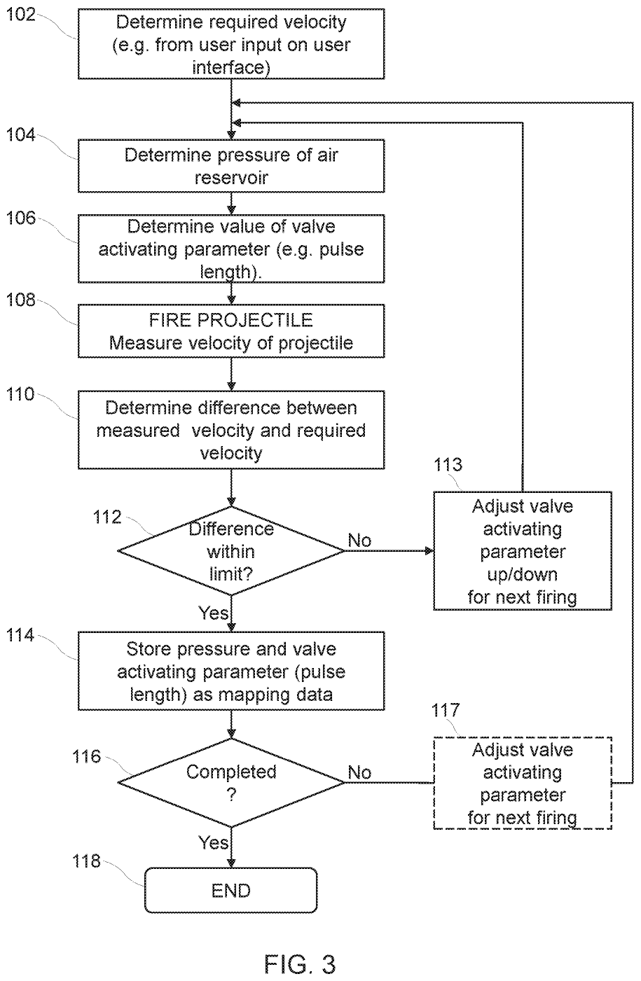

FIG. 3 shows an example of a method of operating the gun to acquire mapping data. The mapping data maps values of pressure (in the air reservoir 16) to values of a valve activating parameter (pulse length) to achieve a particular velocity. An accurate set of mapping data allows the gun to fire a projectile to within a close limit of a required velocity for a range of different reservoir pressures. The method may be performed by the GCU 40.

At block 102 the method determines a required velocity. The required velocity may be entered by a user via a user interface of the gun, or may be received at the GCU via some other means. This is typically a value expressed in feet per second (FPS) or meters per second.

At block 104 the method determines pressure within the air reservoir 16, or pressure in an air flow path at a position downstream of the air reservoir 16, such as the plenum chamber 19. The pressure sensor 18 provides a pressure reading. At block 106 the method determines a value of a valve activating parameter (e.g. a pulse length to close the switch 62). If this is the first iteration of the method, the method may retrieve an initial “seed” value of the valve activating parameter from memory 50. If this is a second, or further, iteration of the method, the method will already have a value for the valve activating parameter based on the last firing (block 114).

At block 108 a projectile is fired. The method uses the value of the valve activating parameter determined by block 106. The method determines velocity of the projectile using data from the chronoscope 30. At block 110 the method determines a difference between the measured velocity and the required velocity (from block 102) is within a required limit. The required limit may be a value stored in memory 50. The required limit may be an absolute threshold value (e.g. 1 m/s) or it may be a relative threshold value (e.g. a percentage of the required velocity). If the difference is not within the required limit, the method proceeds to block 113. The valve activating parameter is adjusted up or down. The purpose is to achieve a velocity which is closer to the required velocity on the next firing. For example, if the measured velocity is less than the required velocity then the pulse length is increased to increase the quantity of air released from the reservoir on the next firing. This will increase the velocity of the next firing. If the measured velocity is higher than the required velocity then the pulse length is reduced to reduce the quantity of air released from the reservoir on the next firing. This will reduce the velocity of the next firing. The method returns to block 104 or directly to block 106 or block 108. The updated value of the pulse length is used for the next firing.

Returning to block 112, if the difference is within the required limit, the method proceeds to block 114. The pressure (block 104) and valve activating parameter (pulse length) are stored in memory 50. These values can be used as mapping data for a subsequent firing of the gun. At block 116 the method checks if it has met the requirement(s) to end. For example, the method may end when the pressure in the air reservoir has reached a predetermined value, or some other requirement. If the method has not met the requirement(s) to end, the method may return to block 104 or to some other block before the next firing. Optionally, the method proceeds to block 117 where the valve activating parameter is adjusted up or down. For example, a value of pulse length may be reduced before the next firing to account for the reduction in pressure between shots. If the method has met the requirement(s) to end, the method ends at block 118.

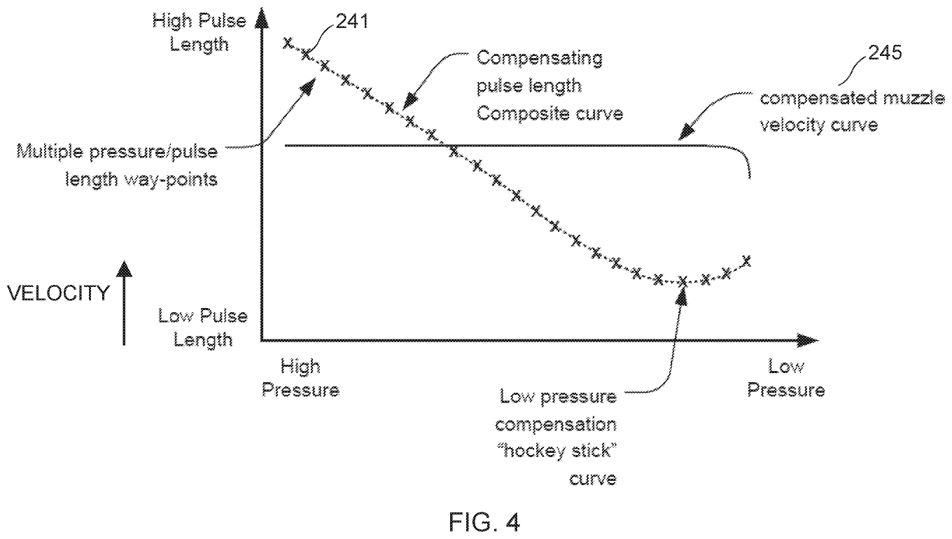

It will be appreciated that the above method allows the gun to acquire an accurate set of mapping data by itself. That is, the gun is self-learning. Once a set of mapping data has been acquired, the gun can use the mapping data to obtain a value of the valve activating parameter (pulse length) during any subsequent operation of the gun. The GCU only needs to determine pressure in the air reservoir (via pressure sensor 16) and perform a look-up in the mapping data (FIG. 4). The set of mapping data can have a larger number of data waypoints compared to a factory-calibrated data set. For example, the number of stored waypoints may be of the order of tens or hundreds.

After the learning process of FIG. 3, the gun can continue to compensate for any changes to the stored values of mapping data introduced by factors such as temperature and/or gun wear. The velocity of a projectile varies according to air temperature. Temperature affects the properties of air and behaviour of components of the gun. The velocity of a projectile varies according to gun wear. As components wear their properties change. For example, the valve return spring of a new valve will typically have a higher closing force compared to an older valve. The method of FIG. 3 may be used during subsequent operation of the gun to verify, or adjust, the mapping data.

The mapping data which is acquired by this method (“self-learnt mapping data”) can be stored in addition to any factory-calibrated mapping data, or seed values. For example, the self-learnt mapping data may be stored in a first memory location, and the factory-calibrated mapping data may be stored in a second memory location. The self-learnt mapping data may be stored in a non-volatile memory at some point before the gun powers down. This allows the self-learnt mapping data to be used during a subsequent operation of the gun.

FIG. 4 shows an example set of mapping data presented as a graph of pulse length against reservoir pressure. A plurality of waypoints 241 are plotted on this graph. Each waypoint is a pair of data values: (i) pulse length and (ii) pressure which have been obtained by the gun, such as by using the method of FIG. 3. It is noted the graph can represent a non-linear relationship between pulse length and pressure. For example, the line in this example graph has a “hockey stick” shape. At low pressures a longer pulse length is needed. The set of mapping data can accurately represent the relationship for the gun. During operation, the GCU performs a look-up operation in the table of existing mapping data. The GCU looks up a value of pulse length corresponding to the current pressure in the air reservoir obtained by the pressure sensor. If the mapping data does not contain an entry for the reservoir pressure value, the GCU may use a data processing technique, such as interpolation, to obtain a pulse length value for the pressure. For example, if values are known on each side of the required (unknown) pressure, interpolation allows the value to be calculated for the unknown value. FIG. 4 also shows a velocity curve 245 (velocity against pressure) of the gun across the range of pressures when the gun uses this set of mapping data. The velocity remains substantially constant across a wide range of pressures.

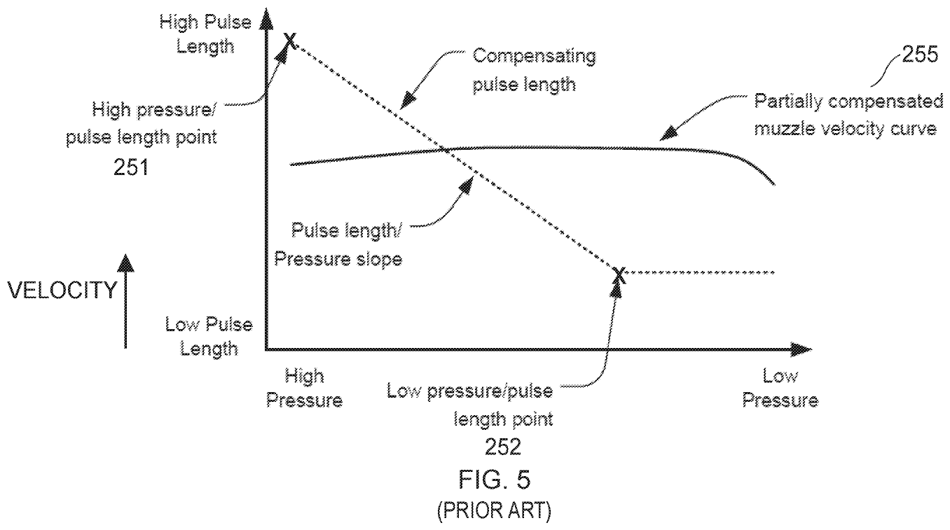

FIG. 5 shows, for comparison purposes, a prior art example set of mapping data presented as a graph of pulse length against reservoir pressure. This graph may be based on a small number of waypoints, such as only two points 251, 252. Typically, at manufacture the gun is setup on a bench using a standalone chronoscope with a manually operated programmer (i.e. a machine to control the GCU to store data values) connected to a programming port of the GCU. FIG. 5 also shows a velocity curve 255 (velocity against pressure) of the gun across the range of pressures when the gun uses this set of mapping data. Comparing the velocity curves of FIG. 4 and FIG. 5, it can be seen that the compensated velocity curve of FIG. 4 has a more constant velocity across a wide range of pressures.

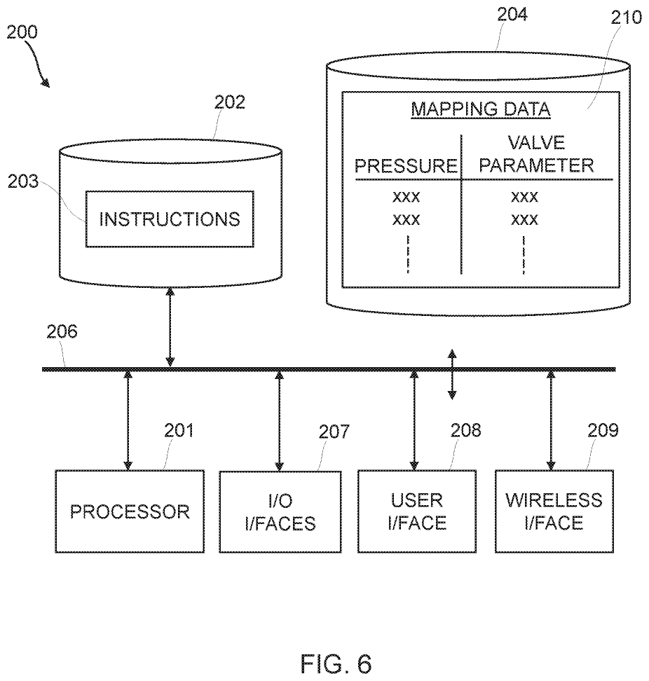

FIG. 6 shows an example of a controller 200 which may implement the GCU 40. The controller 200 may implement all, or part of, the method described above. Controller 200 comprises one or more processor 201 which may be any type of processor for executing instructions to control the operation of the device. The processor 201 is connected to other components of the device via one or more buses 206. Processor-executable instructions 203 may be provided using any data storage device or computer-readable media, such as memory 202. The processor-executable instructions 203 comprise instructions for implementing the functionality of the described methods. The memory 202 is of any suitable type such as non-volatile memory, a magnetic or optical storage device. Mapping data 210 may be stored in the data storage device 202, or in a separate data storage device 204. The processing apparatus 200 comprises input/output (I/O) interfaces 207. The I/O interfaces 207 can receive signals from other parts of the gun, such as the inputs 43-47 shown in FIG. 2. The I/O interfaces 207 can output signals to other parts of the gun, such as the control signals 48, 49 shown in FIG. 2. The processing apparatus 200 connects to a user interface 208. The processing apparatus 200 connects to a radio interface 209 for wirelessly interfacing with other apparatus.

The GCU 40 may be provided with a suitable interface, such as a programming serial port, which may be used to test the GCU 40 in manufacture and to store firmware into an on-board microprocessor.

The GCU 40 may connect to a wireless interface. This can allow the GCU to communicate with wireless peripherals such as: range finders; electronic sighting systems; mobile phones; tablets; computers. The wireless interface may use a wireless technology such as Bluetooth™ or some other suitable wireless protocol. The GCU 40 monitors the status of the battery 5 and warns the user if the battery is low.

Off Gun Calibration System (ATE)

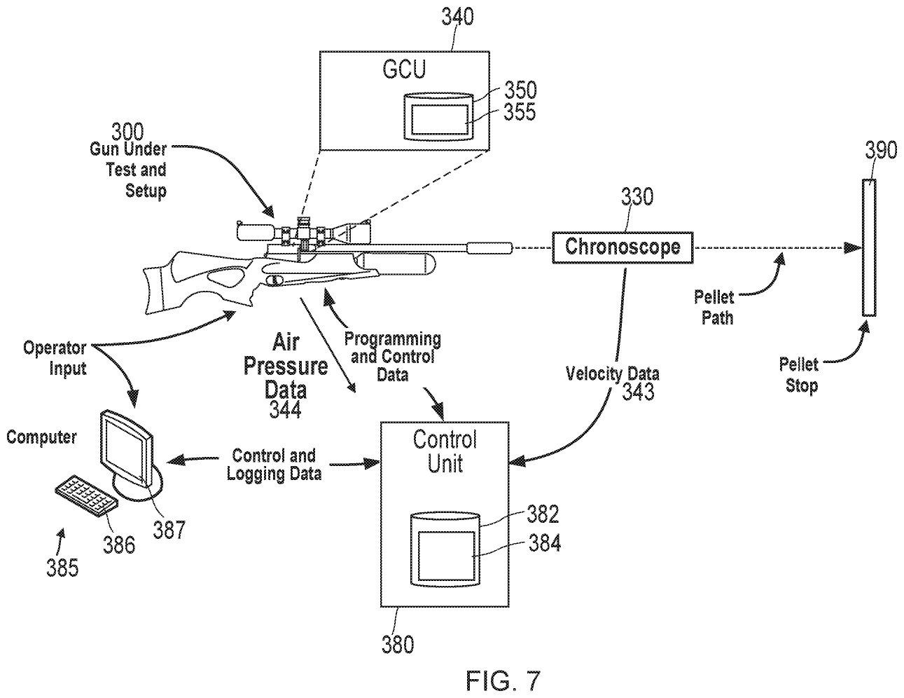

FIG. 7 shows a system for configuring a pneumatic air gun 300. The pneumatic air gun 300, may be the same, or similar to, the gun 10 shown in FIGS. 1 and 2. Alternatively, the pneumatic air gun 300, may be a gun which lacks a chronoscope and lacks a controller GCU which is able to acquire mapping data during operation.

The control unit 380 of FIG. 7 can acquire mapping data to allow the gun 300 to operate at a required velocity. When the control unit 380 has acquired mapping data, the mapping data is transferred to the memory 350 of the gun under test and is used by the GCU 340 of the gun under test. The mapping data configures operation of the gun 300. During operation of the gun 300, the GCU 340 of the gun 300 uses the mapping data to map a current pressure of the reservoir (or plenum chamber) to a value of pulse length to operate the valve of the gun. This can maintain the gun at a substantially constant operating velocity across a range of pressures.

The system of FIG. 7 may be provided in a factory, or at some other test or maintenance facility. A gun under test 300 is fixed to the bench. The gun under test 300, chronoscope 330 and pellet stop 390 may conveniently be mounted to a test bench. The gun under test 300 is aimed such that it will fire pellets (or some other type of projectile) through the chronoscope 330 and to the pellet stop 390.

The chronoscope 330 (also called a chronograph) is a stand-alone device which is separate from the gun 300 under test. The chronoscope 330 can be a bench-mountable chronoscope. The chronoscope 330 may either directly output velocity data 343, or output data which can allow control unit 380 to calculate velocity. The chronoscope 330 may measure velocity using optical barriers or any other suitable technology. The velocity data 343 is sent to the control unit 380.

The control unit 380 receives data from the gun 300 and from the chronoscope 330. The control unit 380 is configured to obtain mapping data (pressure and pulse length) which will cause the gun 300 to operate at a substantially constant velocity across a range of pressures. Constant velocity is equivalent to constant energy where the same pellet type is used. Data received from the gun 300 includes a pressure of an air reservoir of the gun 300, a plenum chamber of the gun 300, or pressure at some other point downstream of the air reservoir. The control unit 380 is configured to compare the velocity of a fired pellet (using velocity obtained via the chronoscope 330) with a required velocity. The control unit 380 computes the pulse length necessary against pressure, to keep the velocity constant around the chosen velocity setting, using closed-loop feedback. The control unit 380 sends the computed pulse length to the gun 300. The control unit 380 has an interface to a computer 385 which controls the system via operator input and logs the gun's performance data.

A closed loop feedback loop consisting of the gun, chronoscope and programming and control unit is used to regulate the pellet velocity around the chosen velocity setting and pulse length and multiple pressure/pulse length waypoints are stored as a map to be programmed into the gun. The mapping data obtained in this way provides a constant muzzle energy and therefore a constant velocity for a particular type of projectile. Different projectile types may have a different mass, and therefore the velocity will differ for other projectile types.

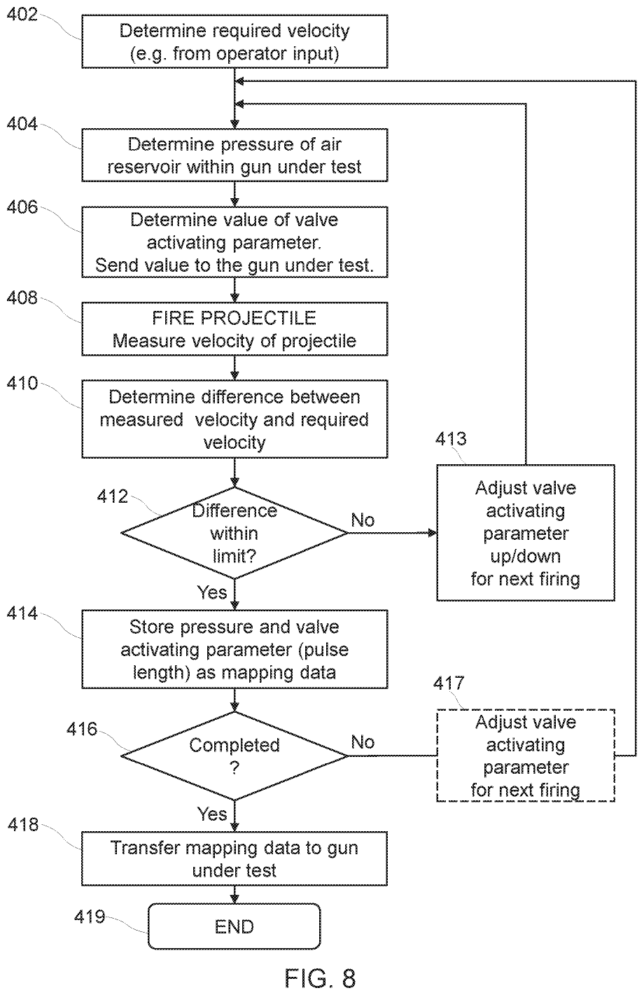

FIG. 8 shows an example of a method of operating the control unit 380 in the system of FIG. 7 to acquire mapping data. The method is generally the same as the flow chart shown in FIG. 3. Some differences arise from where measurements are made, which control entity controls operation, and transfer of mapping data between control unit 380 and the GCU 340 of the gun under test 300.

The method acquires a set of mapping data which maps values of pressure (in the air reservoir 16 of the gun under test) to values of a valve activating parameter (pulse length) to achieve a particular velocity. An accurate set of mapping data allows the gun to fire a projectile to within a close limit of a required velocity for a range of different reservoir pressures.

At block 402 the method determines a required velocity. The required velocity may be entered by a technician at computer 385. At block 404 the method determines pressure within the air reservoir 16 of the gun under test, a plenum chamber of the gun 300, or pressure at some other point downstream of the air reservoir. A pressure sensor 18 of the gun provides a pressure reading which is communicated to the control unit 380. At block 406 the method determines a value of a valve activating parameter (e.g. a pulse length to close the switch 62). If this is the first iteration of the method, the method may retrieve an initial “seed” value of the valve activating parameter from a memory 382 of the control unit 380. If this is a second or further iteration of the method, the method will already have a value for the valve activating parameter based on the last firing (block 414).

At block 408 the gun is operated to fire a projectile. The gun may be manually fired by an operator, or apparatus may be provided to automate firing of the gun in response to a control signal from control unit 380. The method uses the value of the valve activating parameter from block 406. The method determines velocity of the projectile using data from the chronoscope 330. At block 410 the method determines a difference between the measured velocity and the required velocity (from block 402) is within a required limit. The required limit may be a value stored in memory 382 of the control unit 380. The required limit may be an absolute value or it may be a relative value (e.g. a percentage of the required velocity). If the difference is not within the required limit, the method proceeds to block 413. The valve activating parameter is adjusted up or down. The purpose is to achieve a velocity which is closer to the required velocity on the next firing. For example, if the measured velocity is less than the required velocity then the pulse length is increased to increase the quantity of air released from the reservoir. This will increase the velocity of the next firing. If the measured velocity is higher than the required velocity then the pulse length is reduced to reduce the quantity of air released from the reservoir. This will reduce the velocity of the next firing. The method returns to block 404 or directly to block 406 or block 408. The updated value of the pulse length is used for the next firing.

Returning to block 412, if the difference is within the required limit, the method proceeds to block 414. The pressure (block 404) and valve activating parameter (pulse length) are stored in memory 382. These values can be used as mapping data for a subsequent firing of the gun. At block 416 the method checks if it has met the requirement(s) to end. For example, the method may end when the pressure in the air reservoir has reached a predetermined value, or some other requirement. If the method has not met the requirement(s) to end, the method may return to block 404 or to some other block before the next firing. Optionally, the method proceeds to block 417 where the valve activating parameter is adjusted up or down. For example, a value of pulse length may be reduced before the next firing to account for the reduction in pressure between shots. If the method has met the requirement(s) to end, the method proceeds to block 418. The mapping data is transferred to the gun under test 300. The mapping data is transferred from memory 382 to memory 350 of the gun under test 300. The transfer may be performed by control unit 380. Mapping data may be transferred at the end of a test cycle, or during a test cycle.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. An apparatus for acquiring data for configuring a pneumatic air gun, the apparatus comprising:
a data storage device;
a controller configured to:
determine a required velocity for a firing;
determine a pressure of an air reservoir, or a pressure in an air flow path at a position downstream of the air reservoir of the gun;
determine a value of a valve activating parameter for the firing, wherein the valve activating parameter is for an electrically operated valve to release a quantity of air from an air reservoir of the gun to fire a projectile;
determine a measured velocity of a projectile fired from the gun using the determined value of the valve activating parameter;
determine whether a difference between the measured velocity and the required velocity is within a required limit; and
store the determined pressure and the determined value of the valve activating parameter in the data storage device as mapping data for configuring a future firing of the gun when the difference between the measured velocity and the required velocity is within the required limit.

2. The apparatus according to claim 1 wherein the controller is configured to acquire a set of mapping data for a plurality of different determined pressures at the required velocity.

3. The apparatus according to claim 1 wherein the controller is configured to:
adjust a value of the valve activating parameter when a difference between the measured velocity and the required velocity is outside the required limit; and
use the adjusted value of the valve activating parameter for a subsequent firing.

4. The apparatus according to claim 3 wherein the controller is configured to adjust the value of the valve activating parameter to increase quantity of air released from the reservoir if the measured velocity is less than the required velocity.

5. The apparatus according to claim 3 wherein the controller is configured to adjust the value of the valve activating parameter to reduce a quantity of air released from the reservoir if the measured velocity is higher than the required velocity.

6. The apparatus according to claim 1 wherein the controller is configured to retrieve, from the data storage device, an initial value of the valve activating parameter and use the starting value.

7. The apparatus according to claim 1 wherein the required velocity is a user-selectable velocity value.

8. The apparatus according to claim 1 wherein the controller is coupled to a user interface, and the user interface is configured to allow a user to select the required velocity.

9. The apparatus according to claim 1 wherein the valve activating parameter is a pulse length or a pulse voltage.

10. The apparatus according to claim 9 wherein the electrically-operated actuator is a solenoid.

11. A pneumatic air gun comprising:
a barrel;
a pressure sensor configured to determine a pressure of an air reservoir, or a pressure in an air flow path at a position downstream of the air reservoir of the gun;
a velocity measuring device configured to measure measured velocity of a projectile fired along the barrel of the gun; and
the apparatus according to any one of the preceding claims, wherein the data storage device and the controller form part of the pneumatic air gun.

12. A system for configuring a pneumatic air gun comprising the apparatus according to claim 1, wherein the controller is separate to the pneumatic air gun, and the controller is configured to:
determine the pressure of an air reservoir, or a pressure in an air flow path at a position downstream of the air reservoir of the gun using a pressure sensor of the pneumatic air gun;
send the value of the valve activating parameter for the firing to the pneumatic air gun; and
determine the measured velocity of a projectile fired from the gun using a velocity measuring device which is separate to the pneumatic air gun.

13. The system according to claim 12 wherein the controller is configured to transfer the mapping data to an on-gun controller of the pneumatic air gun under test to configure operation of the gun.

14. A method of acquiring data for controlling operation of a pneumatic air gun, the pneumatic air gun comprising an air reservoir, an electrically operated valve operable to release a quantity of air from the air reservoir to fire a projectile and a velocity-measuring device configured to measure a velocity of a fired projectile, the method comprising:
determining a required velocity for a firing;
determining a pressure of the air reservoir;
determining a value of a valve activating parameter for the firing;
determining a measured velocity of a projectile fired using the determined value of the valve activating parameter;
determining whether a difference between the measured velocity and the required velocity is within a required limit; and
storing the determined pressure and the determined value of the valve activating parameter in a data storage device as mapping data for a future firing of the gun when the difference between the measured velocity and the required velocity is within the required limit.

15. The method according to claim 14 which is performed by a controller on the pneumatic air gun, wherein:
the step of determining a pressure of an air reservoir, or a pressure in an air flow path at a position downstream of the air reservoir of the gun uses a pressure sensor of the pneumatic air gun;
the step of determining a measured velocity of a projectile uses a velocity measuring device on the barrel of the pneumatic air gun.

16. The method according to claim 14 which is performed by a controller separate to the pneumatic air gun, wherein:
the step of determining a pressure of an air reservoir, or a pressure in an air flow path at a position downstream of the air reservoir of the gun, uses a pressure sensor of the pneumatic air gun;
the step of determining a value of a valve activating parameter for the firing sends the determined value of the valve activating parameter to the pneumatic air gun;
the step of determining a measured velocity of a projectile uses a velocity measuring device which is separate to the pneumatic air gun; and
the method comprises transferring the mapping data to an on-gun controller of the pneumatic air gun under test to configure operation of the gun.

17. A computer program product comprising a machine-readable medium carrying instructions which, when executed by a processor, cause the processor to perform the method of claim 14.
